(19) United States
(12) Patent Application Publication
(10) Pub. No.: US 2010/0109616 A1
(43) Pub. Date: May 6, 2010

(54) System and method for reactive power compensation and flicker management

(76) Inventors: Huaqiang Li, Menomonee Falls, WI (US); Yong Kang, Wuhan (CN); Xinchun Lin, Wuhan (CN); Xiaohu Liu, Tallahasee, FL (US)

Correspondence Address: EATON CORPORATION;EATON CENTER, 1111 SUPERIOR AVENUE, CLEVELAND, OH, 44114, US

(21) Appl. No.: 12/590,178

(22) Filed: Nov. 4, 2009

Related U.S. Application Data
(60) Provisional application No. 61/198,278, filed on Nov. 4, 2008.

(51) Int. Cl. G05F 3/04

(52) U.S. Cl. 323/210

(57) ABSTRACT

A Thyristor Switched Capacitor (TSC) system connected to three sets of diodes and thyristors connected in parallel with the diodes being in an anti-parallel configuration, three capacitors connected in series with the diodes and thyristors, and three surge current controlling reactors that control the transient time to improve power quality in the grid.

### CROSS-REFERENCE TO RELATED APPLICATIONS

This application claims priority to U.S. Provisional Application No. 60/198,278 filed on Nov. 4, 2008, the disclosure of which is hereby incorporated by reference in its entirety.

### BACKGROUND

The present invention relates to power quality and more particularly to stabilization of power quality using dynamic reactive power compensation and flicker management in non-linear power generation (e.g., Wind and Solar) and distribution systems.

Electricity distribution utilities supply power to consumers and commercial users through an electricity distribution grid. The power quality supplied via utility grid is quantified by parameters such as stability, symmetry and current waveform characteristics. In addition to existing electricity generation sources, e.g., hydroelectric and thermal, in recent times renewable energy generation sources are being joined to the grid, e.g., solar and wind power.

Renewable electricity generation sources, e.g., solar and wind power, generate non-linear loads because they are dependent on variable natural sources like sunlight and wind. Non-linear sources in electricity generation need to be stabilized before they can be connected to the electricity distribution grids. Stabilization can also introduce distortions in power quality. For example, mass application of various power electronic devices and frequent fluctuation of loads negatively impact the grid power quality.

The non-linearity and distortion in grid power quality can lead to multiple problems; some such problems are described next. For example, power quality in the grid deteriorates due to low power factors, high power losses, high capital and maintenance costs and low efficiency. Deterioration in power quality can lead to reactive power impact, voltage drops and voltage flicker of the grid resulting in driving and protection equipment's malfunction or shutdown. Some illustrations of problems caused by harmonic currents are: grid voltage distortion, faulty protective equipment, and the amplification of resonance and harmonic currents of the capacitors, which can lead to capacitor overload or over-voltage failures. Further examples of problems are: increased loss of transformer leading to overheating, electrical equipment overheating, motor instability, accelerated insulation deterioration, reduced efficiency in electric arc furnaces and higher losses and disturbance in communication signals. Due to power quality problems, the three-phase imbalance with negative sequence currents can lead to vibrations of electric machines.

Power quality and stability can be improved in non-linear power generation systems by including a fast responding power stabilizing system in the systems as described next. For example, a Static Synchronous Compensator (STATCOM) can provide quick power stabilization, for a relatively high cost, in wind-farm like power generating systems. A Thyristor Switched Capacitor (TSC) can be combined with the STATCOM to improve power quality in non-linear power generation systems.

A combination of TSC and STATCOM needs to resolve transient disturbances resulting from the switching action of the TSC. During the switching action of the TSC, a long transient duration could result in grid power quality problems. In another approach, components can be increased, with a significant cost penalty, in the system to avoid high-frequency inrush current and a corresponding voltage transient when TSC is connected to the grid.

### SUMMARY

A system and method for controlling transient disturbances in an electrical system, particularly electrical systems with non-linear power sources, is described. The system includes a Thyristors Switched Capacitor (TSC) in combination with a STATCOM connected to electrical phases. The TSC configuration includes a diode and a thyristor.

The switching sequences of the TSC achieve a switching time of T/3 of the line frequency cycle. The system can be implemented in a delta or a Wye-type configuration. The switching sequences can be in any combination.

### BRIEF DESCRIPTION OF THE DRAWINGS

FIG. 1A illustrates a prior-art Thyristor Switched Capacitor (TSC);

FIG. 1B illustrates a TSC for power quality regulation;

FIG. 2 shows a prior-art three phase TSC configuration;

FIGS. 3A-3C show a prior-art TSC configuration's transient performance graphs for the FIG. 2's TSC configuration;

FIG. 4 shows a multi phase TSC configuration with a thyristor-diode combination;

FIGS. 5A-5C show the transient performance graphs for the FIG. 4's TSC configuration;

FIGS. 6A-6B show switching sequences for TSC configurations;

FIG. 7 shows a delta type configuration of the TSC; and

FIG. 8 shows a wind power system with a power quality management system

### DETAILED DESCRIPTION

Referring now to the drawings, which are not intended to limit the invention, FIG. 1A illustrates a prior-art Thyristor Switched Capacitor (TSC). FIG. 1B illustrates a TSC for power quality regulation. A TSC includes a thyristor switch and a capacitor bank. TSCs have switching capabilities to support the supply voltage of distribution systems and correct the power factor of the connected loads. TSCs generally are resistant to mechanical wear, noise-free and capable of transient-free switching.

The prior-art TSC 10 includes a bi-directional thyristor valve that includes thyristors 12 and 14 connected in parallel. The exemplary TSC 10 is connected to a single phase electrical distribution system. The TSC 10 is expected to be switched on with minimum transient disturbance. The TSC 10 also includes a capacitor 16 and an inductor 18 to control a surge current inflow. Before being switched on, the voltage level of capacitor 16 is zero. To achieve minimum transient when the TSC 10 is switched on, the capacitor is kept pre-charged to a certain voltage level before the switching action happens.

With reference to FIG. 1B, a TSC 20 for a single phase system includes a diode 22 in an anti-parallel arrangement with a thyristor 24. The function of TSC 20 is to reduce the transient disturbance that occurs at switching time to a minimum. A TSC 20 also includes a capacitor 26 and a surge limiting reactor, e.g., a series inductor. The TSC 20 is switched off at the current zero crossing with no transient disturbance (similar to TSC 10). When connected to a grid, the voltage level of capacitor 26 is kept the same as the maximum voltage level of the grid due to the presence of the diode 22 in the circuit. The TSC 20, unlike TSC 10 which needs capacitor 16 to be pre-charged, can be switched on when the grid voltage reaches the peak value.

The TSC 10 requires an additional circuit (not shown) to pre-charge the capacitor 16, but TSC 20 requires no such circuit because of presence of diode that keeps the capacitor 26 charged to the maximum grid voltage level.

The working of TSC 20 is described next. If the supply voltage for the TSC 20 is given by ν=V sin(ωₒt+α), time is measured when the thyristor is gated, corresponding to the angle α on the voltage wave. The voltage equation in terms of the Laplace transforms will be:

$$V ( s ) = [ Ls + \frac{1}{Cs} ] I ( s ) + \frac{{V}_{co}}{s} \qquad ( 1 )$$

By manipulating the Laplace inverse transformation, the instantaneous current is obtained as:

$$i ( t ) = {I}_{α c} cos ( {ω}_{o} t + α ) - {nB}_{c} [ \begin{matrix}{V}_{co} - \\ \frac{{n}^{2}}{{n}^{2} - 1} V sin α\end{matrix} ] sin {ω}_{n} t - {I}_{α c} cos α cos {ω}_{n} t \qquad ( 2 )$$

Where

$${B}_{c} = {ω}_{o} C , {I}_{α c} = V \cdot {B}_{c} \frac{{n}^{2}}{{n}^{2} - 1} , {ω}_{n} = 1 / \sqrt{LC} = n {ω}_{o} , n = \frac{{ω}_{n}}{{ω}_{o}} = \sqrt{{X}_{c} / {X}_{L}} .$$

ωₙ is the natural frequency of the circuit.

The last two terms in equation (2) above represent the expected oscillatory components of current having the frequency ωₙ. In practice, resistance causes these terms to decay. Hence, the voltage gap between capacitor initial voltage and the grid voltage at the switching time affects the inrush current peak amplitude. If the voltage gap is very large, the inrush high-frequency current is very large and the corresponding transient time is very long.

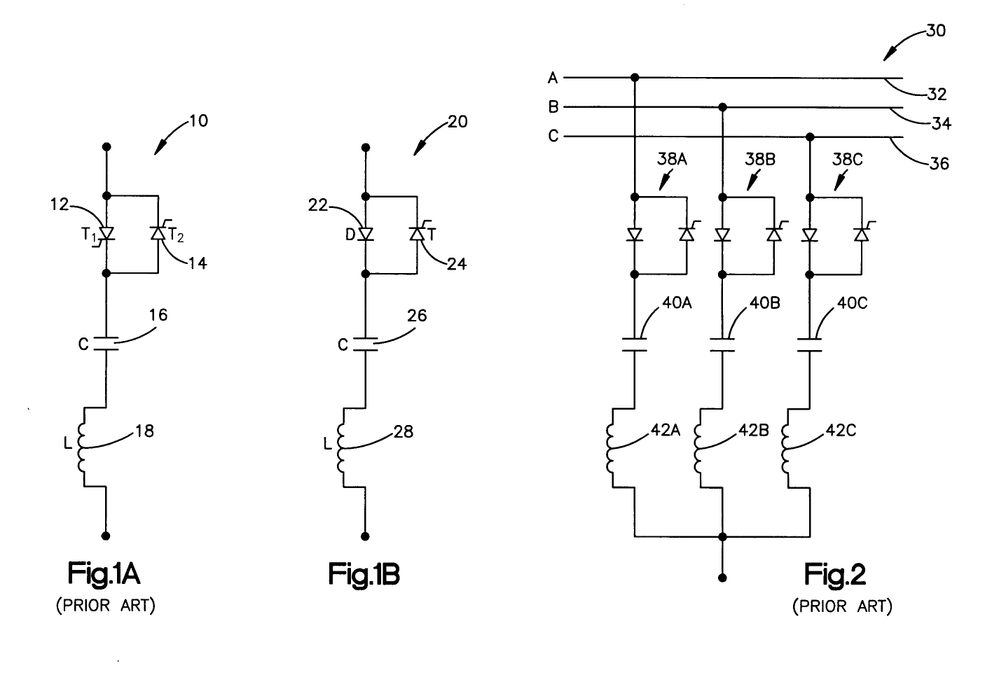

FIG. 2 shows a prior-art three phase TSC configuration. A TSC configuration 30 connects to three phases via phase A line 32, phase B line 34 and phase C line 36. The three TSCs 38A-C have two thyristor configuration and operate as described above with reference to FIG. 1A. The three capacitors 40A-C may require pre-charging before switching for the TSCs 38A-C can happen. Inductors 42A-C provide surge current control.

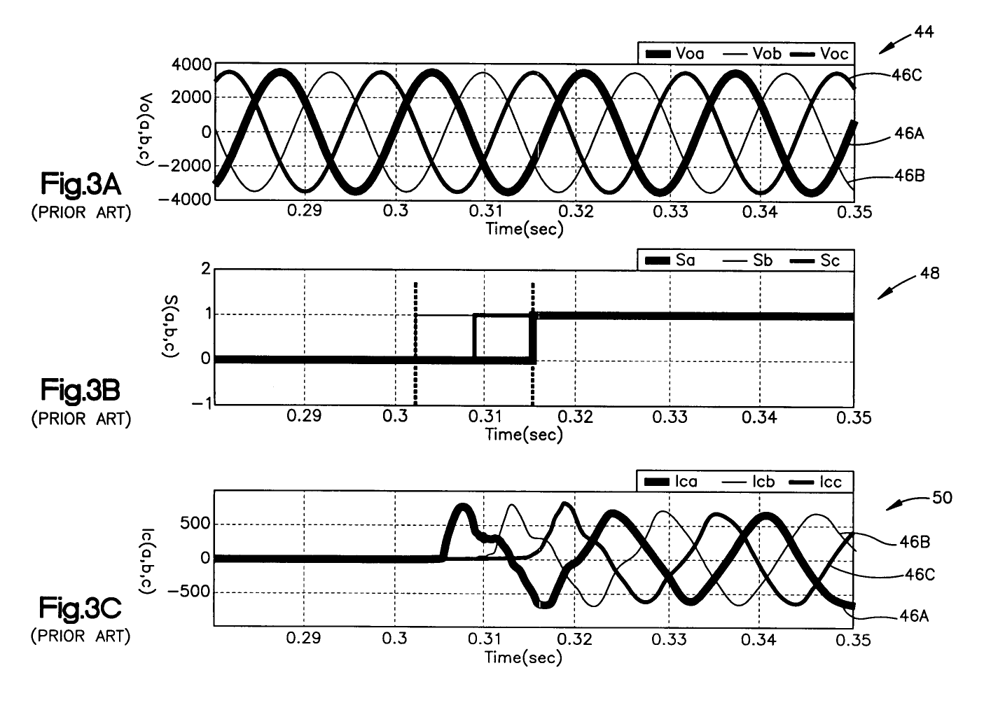

FIGS. 3A-3C shows a prior-art TSC configuration's transient performance graphs for the FIG. 2 TSC configuration. FIG. 3A shows grid voltages; FIG. 3B shows gate commands to switch on and off the Thyristors (SCRs); and FIG. 3C shows the thyristor branch currents. The graph 44 shows three grid voltages Voa 46A, Vob 46B and 46C for three phases. The graph 46 shows the gate commands to switch on and off the thyristors 38A-C (See FIG. 2). The graph 46 shows that the minimum transient time in the TSC configuration shown in FIG. 2 is 2T/3 of a line frequency period. The capacitors 40A, 40B and 40C (See FIG. 2) are switched on sequentially, i.e., for phase sequence A-B-C representing switching for phases 32, 34 and 36 (See FIG. 2) respectively. The phase switching sequence A-B-C for two thyristor TSC configuration of FIG. 2 leads to a switching time of 2T/3. Referring to FIG. 3C, the transient lasts a time period of about 2T/3 for the thyristor currents to reach the steady state values.

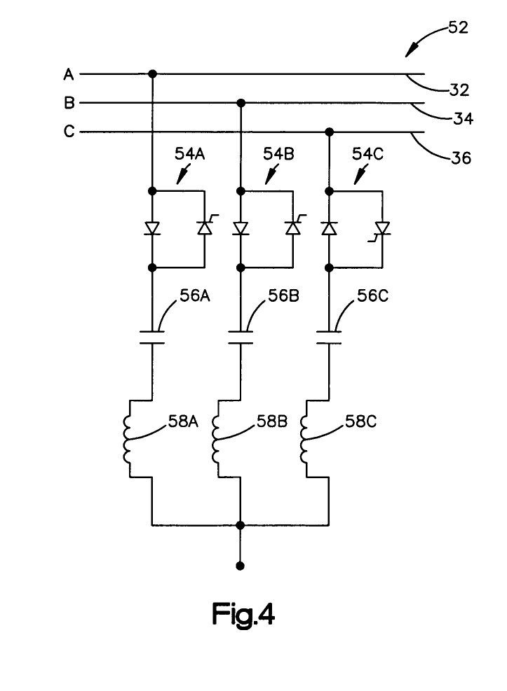

FIG. 4 shows a multi-phase TSC configuration with a thyristor-diode combination. A TSC configuration 52 includes connections to three phases via phase A line 32, phase B line 34 and phase C line 36. The three TSCs 54A-C have a thyristor-diode pair as described above in context of FIG. 1B. The capacitors 56A-C do not need any pre-charging. The inductors 58A-C control or regulate surge current. The TSC configuration can be in a Wye-type arrangement or a delta type arrangement. The Wye-type arrangement is described next and delta type arrangement is described below later. Those skilled in the art will appreciate that either Wye or delta type arrangement could be used for TSC configuration depending on the application need.

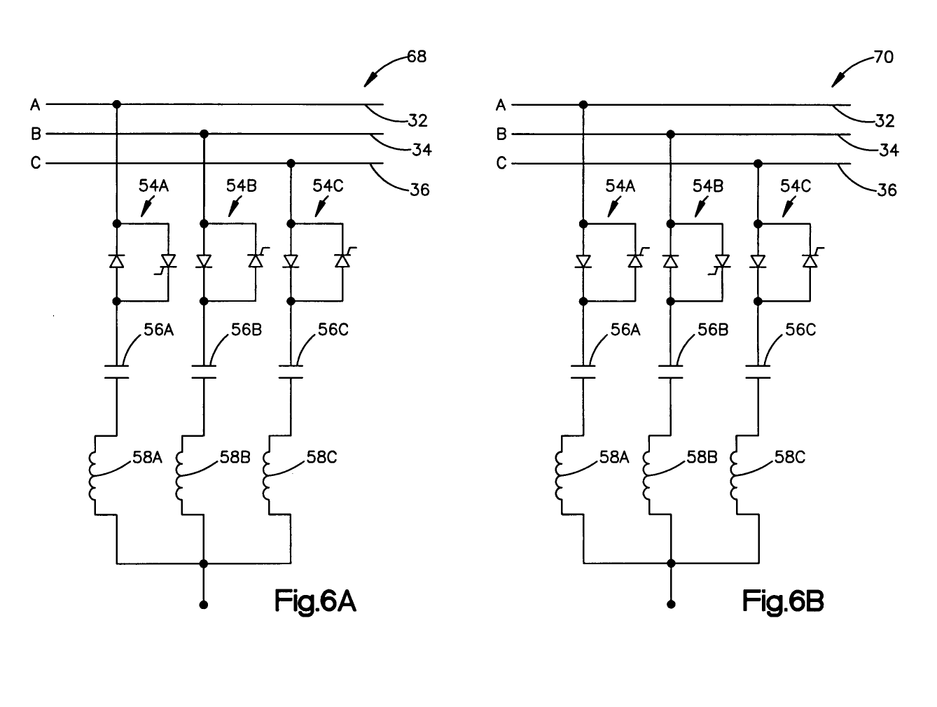

The TSC configurations of TSCs 54A-C reduce the transient time as compared to the transient time required for the TSC configurations shown in FIG. 2 whose working is explained in FIGS. 3A-C. The capacitor 56A-C can be switched in any sequence. The illustrative sequence of switching used here is A-C-B representing switching for phases 32, 36 and 34 respectively. The illustrative phase switching sequence A-C-B for the TSC configuration 52 leads to a switching time of T/3. The current from the grid flows first through phase A line 32 and then phase C line 36 followed by phase B line 34 (See FIG. 4). There is no significant inrush current when the thyristors switch on. The transition time of T/3 for the TSC configuration of FIG. 4 hence is much lower than the 2T/3 transition time of the TSC configuration of FIG. 2. Other switching sequences can also be used; FIGS. 6A-6B illustrate other sequences. Those skilled in the art will appreciate that a particular sequence of switching will depend on a specific application.

A Static Synchronous Compensator (STATCOM) (not shown) is a voltage regulating device used on alternating current (AC) electricity transmission grid networks. A STATCOM can be combined with the TSC configuration 52 to provide improve grid power quality, particularly in grid that are connected to non-linear power generation sources, e.g, solar power, wind power or tidal power. It is based on a power electronics voltage-source converter and can act as either a source or sink of reactive AC power to an electricity grid network. If connected to a source of power it can also provide active AC power. It is a part of the Flexible AC transmission system device family. A STATCOM works by rebuilding the incoming voltage waveform by switching back and forth from inductive to capacitive load. If it is inductive, it will supply reactive AC power. If it is capacitive, it will absorb reactive AC power. Thus, the STATCOM acts as a source or sink.

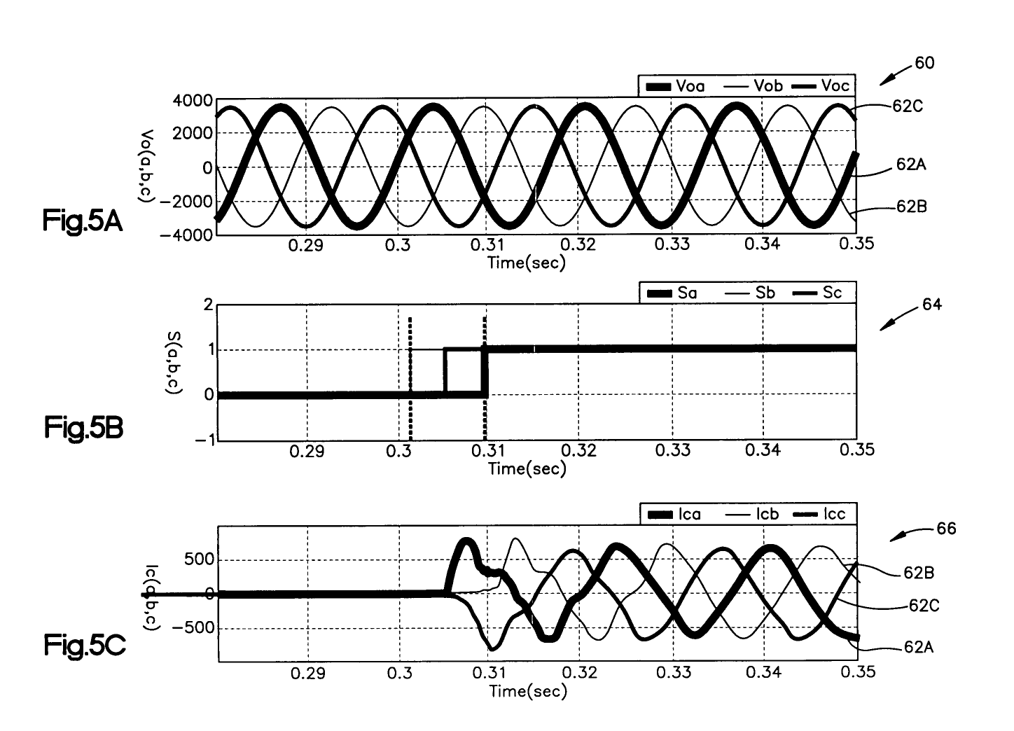

FIGS. 5A-5C show the transient performance graphs for the FIG. 4 TSC configuration. FIG. 5A shows grid voltages; FIG. 5B shows gate commands to switch on and off the Thyristors (SCRs); and FIG. 5C shows the thyristor branch currents. The graph 60 shows three grid voltages Voa 62A, Vob 62B and Voc 62C for three phases. The graph 64 shows the gate commands to switch on and off the thyristors-diode pairs 54A-C (See FIG. 4). The graph 64 shows that the minimum transient time in the TSC configuration shown in FIG. 2 is a third (T/3) of a line frequency period. The capacitors 56A, 56B and 56C (See FIG. 4) can be switched on in any combination of the phase sequences as described below (switching capacitors and TSC are similar concepts).

With reference to FIG. 5B, the procedure for the gate control logic is described as:
1. Measure the input voltages.
2. As an example, after 0.3 s when phase-A reaches its peak value, the gate command for this phase-A Thyristor (SCR), the TSC 54A (See FIG. 4) is allowed to turn on.
3. Next, when phase-A and phase-B voltages cross each other, and phase-C voltage reaches its negative peak value, the gate command for phase-C Thyristor (SCR), i.e, the TSC 54C (See FIG. 4) is allowed to turn on, before phase-B voltage reaches its positive peak value.
4. The following sequence determines the Thyristor (SCR) control of phase-B. When phase-B voltage reaches its positive peak value in time, the gate command for phase-B Thyristor (SCR), i.e., TSC 54B (See FIG. 4) is allowed to turn on.
5. This completes one cycle of the Thyristor gate control sequence.

The graph 66 shows waveforms that represent three-phase thyristor branch currents as a result of this invention. With reference to Voa 62A, Vob 62B and Voc 62C for three phases, the current flows through phase-A first, then phase-C current starts to flow, followed by phase-B current. The sequence is A-C-B. Hence, here is no significant inrush current at Thyristor turn-on. The total transition time is ⅓ of a line frequency period. As compared to the conventional approach, where the turn-on sequence is A-B-C instead, resulting in a longer transition time of ⅔ of a line frequency period.

FIGS. 6A-6B show switching sequences for TSC configurations. A switching sequence of A-C-B phases was described above (See FIGS. 4 and 5A-C). The TSC configurations 68 and 70 are same as the TSC configuration 52 (See FIG. 4) except for the switching sequence. The TSC configuration 68 illustrates the switching sequence of B-A-C for phases 32, 34 and 36 in that sequence. The TSC configuration 70 illustrates the switching sequence of C-B-A. The T/3, line frequency period is obtained in any switching sequence. Those skilled in the art will appreciate that the any switching sequence can be used depending upon the required application.

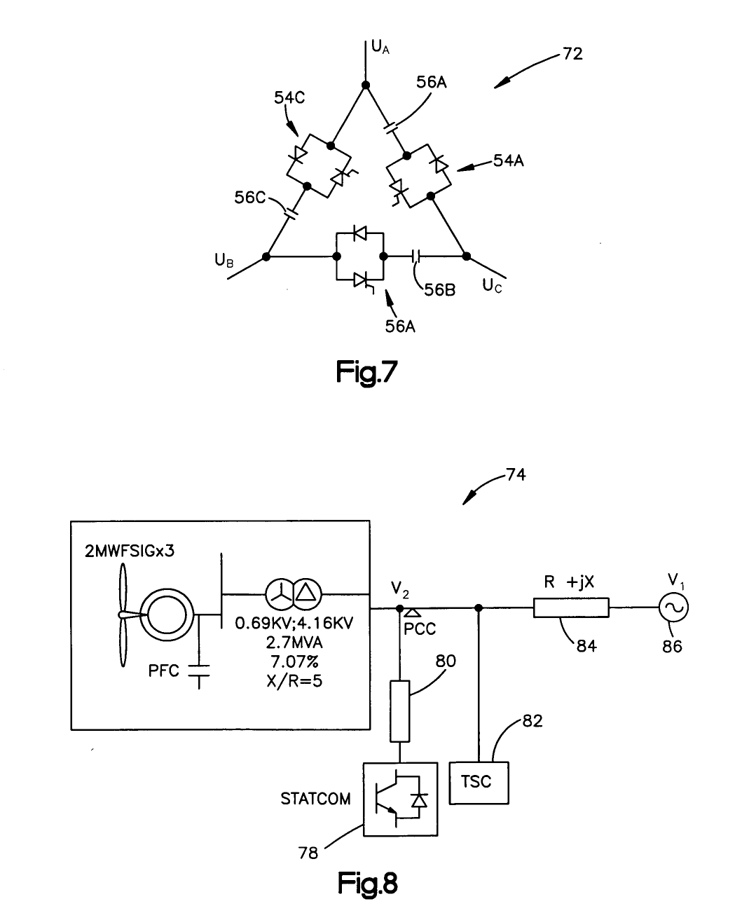

FIG. 7 shows a delta type configuration of the TSC. A delta type TSC configuration 72 includes thyristor-diode pairs 54A-C and capacitors 56A-C that are same as those in FIG. 4. The pairs are connected to three electrical phases (not shown). Inductors 58A-C (See FIG. 4) can be included to limit the current surge. Hence, between any two electrical phases, a thyristor and a diode are connected in parallel. This assembly is then in series with a capacitor bank. The anode and cathode arrangement of the thyristor-diode pairs 54A-C are reversed as compared to known arrangements (not shown). The response time of switching can be improved from 2T/3 to T/3 as those skilled in the art will appreciate.

FIG. 8 shows a wind power system with a power quality management system. An exemplary wind power generating system 76 is connected to a STATCOM 78 via a STATCOM series connected impedance (Zs) 80. A TSC configuration 82 is included in the system. A transmission line impedance (R_{L}_{_{—}}jX_{L}) 84 and a utility voltage source, 86 (V₁) are also included. The grid voltage is kept at its normal level with STATCOM 78 except there is a time span when the limited capacity of the STATCOM cannot provide full voltage support. When STATCOM 78 reaches a maximum output level, the TSC configuration 82 is switched on and the voltage is recovered immediately. The transient time period can be achieved in a time duration of T/3 as described above. A similar configuration can be applied in solar energy generation system where non-linear loads are generated due to variation in sun's radiation and other factors, as those skilled in the art will appreciate.

The invention has been described in detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims.

What is claimed is:

1. A Thyristor Switched Capacitor (TSC) system in an electrical system, the system comprising:
at least one diode and thyristor set connected in parallel in each phase for a multi-phase system, wherein the diode being in an anti-parallel configuration with the thyristor;
at least one capacitor connected in series with the diode and thyristor set in each phase for a multi-phase system; and
at least one surge current controlling reactor in each phase for a multi-phase system.

2. The system of claim 1 further comprising:
a static synchronous compensator for regulating voltage in the system.

3. The system of claim 1 wherein each set of the one diode and thyristor is connected to at least one of three electrical phases.

4. The system of claim 3 wherein each of the three capacitors are switched on in a predetermined switching sequence.

5. The system of claim 4 wherein the TSC system switches to the electrical system within a transient time of at least third of the line frequency period time of the electrical system.

6. The system of claim 1 wherein the three diode and thyristor sets are connected in a Wye-type arrangement.

7. The system of claim 1 wherein the three diode and thyristor sets are connected in a delta arrangement.

8. The system of claim 1 wherein the surge current controlling reactor comprises:
at least one reactor selected from a group comprising a series inductor, reactor or choke.

9. A system for managing power quality in a three-phase electrical system, the system comprising:
a non-linear power source connected to the three-phase electrical system;
a static synchronous compensator for regulating voltage in the system;
and at least three Thyristor Switched Capacitors (TSC) connected to the static synchronous compensator, wherein each of the three TSC being switched in a pre-determined sequence to at least one phase of the electrical system.

10. The system of claim 9 wherein the Thyristor Switched Capacitor (TSC) comprises:
at least one diode and thyristor set connected in parallel, wherein the diodes being in an anti-parallel configuration in each phase for a multi-phase system;
at least one capacitor connected in series with the diode and thyristor sets in each phase for a multi-phase system; and
at least one surge current controlling reactor in each phase for a multi-phase system.

11. The system of claim 10 wherein the three diode and thyristor sets are connected in a Wye-type arrangement.

12. The system of claim 10 wherein the three diode and thyristor sets are connected in a delta arrangement.

13. The system of claim 9 wherein the non-linear power source is a wind powered generator.

14. The system of claim 9 wherein the non-linear power source is a solar powered generator.

15. The system of claim 9 wherein the transient time of switching the TSC is within at least third of a line frequency period time of the electrical system.

16. A method of managing power quality in a three-phase electrical system, the method comprising:
measuring input voltages in each of the three phases of the electrical system;
switching on at least three Thyristor Switched Capacitors (TSC) in a predetermined sequence, wherein the three TSC are connected to the three phase electrical system; and
controlling the transient performance of the TSCs within a third of the line frequency period time of the electrical system.

17. The method of claim 16 further comprising:
regulating the voltage in the electrical system through a static synchronous compensator.
